(19) United States
(12) Patent Application Publication
(10) Pub. No.: US 2022/0311920 A1
(43) Pub. Date: Sep. 29, 2022

(54) IMAGE PICKUP APPARATUS

(71) Applicant: CANON KABUSHIKI KAISHA, Tokyo (JP)

(72) Inventors: Hideki Kawashima, Tokyo (JP); Hirofumi Ozawa, Kanagawa (JP); Kenji Anabuki, Tokyo (JP); Naoko Iwatani, Tokyo (JP); Kaori Yoshida, Tokyo (JP); Keitaro Tsuji, Kanagawa (JP)

(21) Appl. No.: 17/841,121

(22) Filed: Jun. 15, 2022

Related U.S. Application Data
(63) Continuation of application No. PCT/JP2020/038347, filed on Oct. 9, 2020.

(30) Foreign Application Priority Data
Dec. 27, 2019 (JP) 2019-237859

(51) Int. Cl. H04N 5/225; H04N 5/247; A44C 9/00

(52) U.S. Cl. CPC H04N 5/2259; H04N 5/247; H04N 5/2256; H04N 5/2252; H04N 5/225251; A44C 9/0053

(57) ABSTRACT

An image pickup apparatus includes a body including an attachment member for attachment, a ring-shaped rotating member rotatable relative to the body, and an imaging unit configured to capture an image. An imaging angle of view as an imaging parameter is changed by rotating the rotating member.

### CROSS-REFERENCE TO RELATED APPLICATIONS

This application is a Continuation of International Patent Application No. PCT/JP2020/038347, filed on Oct. 9, 2020, which claims the benefit of Japanese Patent Applications No. 2019-237859, filed on Dec. 27, 2019, which is hereby incorporated by reference herein in their entirety.

### BACKGROUND

### Field of the Disclosure

The disclosure relates to a wearable (attachable) image pickup apparatus.

### Description of the Related Art

In capturing an image using a general compact digital camera or camera-attached smartphone, it is necessary to take them out of a bag or a pocket of cloth, and there is a risk of missing a photo opportunity. If you drop the camera or smartphone from your hand, it may get damaged.

Watches with imaging units disclosed in US Patent Application Publication No. 2017/0134645 and Japanese Patent Laid-Open No. 2001-274936 or a watch-type image pickup apparatus disclosed in US Design Patent No. 857526 can capture an image without such a risk. The watch disclosed in US Patent Application Publication No. 2017/0134645 has an imaging unit at the center of the dial, and the image pickup apparatus disclosed in US Design Patent No. 857526 has an imaging unit at the center of a display surface corresponding to the watch dial. The watch disclosed in Japanese Patent Laid-Open No. 2001-274936 has an imaging unit on a side surface of the watch body.

In each of the watches including the imaging units and the image pickup apparatus disclosed in US Patent Application Publication No. 2017/0134645, Japanese Patent Laid-Open No. 2001-274936, and US Design Patent No. 857526 the imaging unit is fixed and the orientation of the imaging unit (imaging direction) cannot be changed unless the user moves the wrist or arm. It is difficult for the user to change an imaging parameter such as an angle of view (focal length) of the imaging unit. That is, the conventional watches including the imaging units and image pickup apparatus are less user-friendly.

### SUMMARY OF THE DISCLOSURE

The disclosure provides an image pickup apparatus that enables a user to easily change an imaging direction and an imaging parameter. The disclosure also provides an image pickup apparatus that is easy to wear and can maintain a stable wearing state.

An image pickup apparatus according to one aspect of the disclosure includes a body including an attachment member for attachment, a ring-shaped rotating member rotatable relative to the body, and an imaging unit configured to capture an image. An imaging angle of view as an imaging parameter is changed by rotating the rotating member.

An image pickup apparatus according to one aspect of the disclosure includes a body including an attachment member for attachment, and an imaging unit configured to capture an image. The attachment member includes string-shaped members, each of which includes two first string-shaped portions fixed to the body so as to extend from two of four locations in the circumferential direction of the body, and a second string-shaped portion configured to connect the two first string-shaped portions.

Further features of the disclosure will become apparent from the following description of exemplary embodiments with reference to the attached drawings.

### BRIEF DESCRIPTION OF THE DRAWINGS

FIG. 1 is a perspective view illustrating an image pickup apparatus according to a first embodiment of the disclosure.

FIG. 2 is a six-view drawing illustrating the image pickup apparatus according to the first embodiment.

FIG. 3 is a perspective view illustrating an image pickup apparatus according to a second embodiment of the disclosure.

FIG. 4 is a six-view drawing illustrating the image pickup apparatus according to the second embodiment.

FIG. 5 is a block diagram illustrating an electrical configuration of the image pickup apparatus according to the first embodiment.

### DESCRIPTION OF THE EMBODIMENTS

Referring now to the accompanying drawings, a description will be given of embodiments according to the disclosure.

### First Embodiment

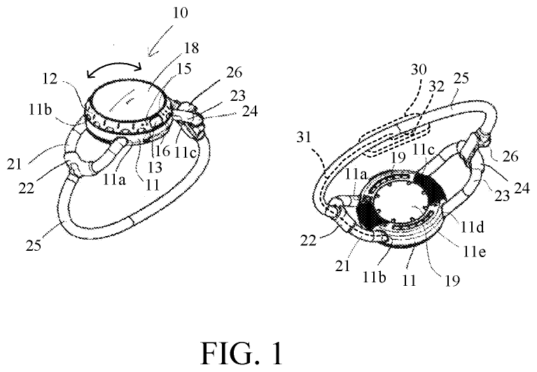

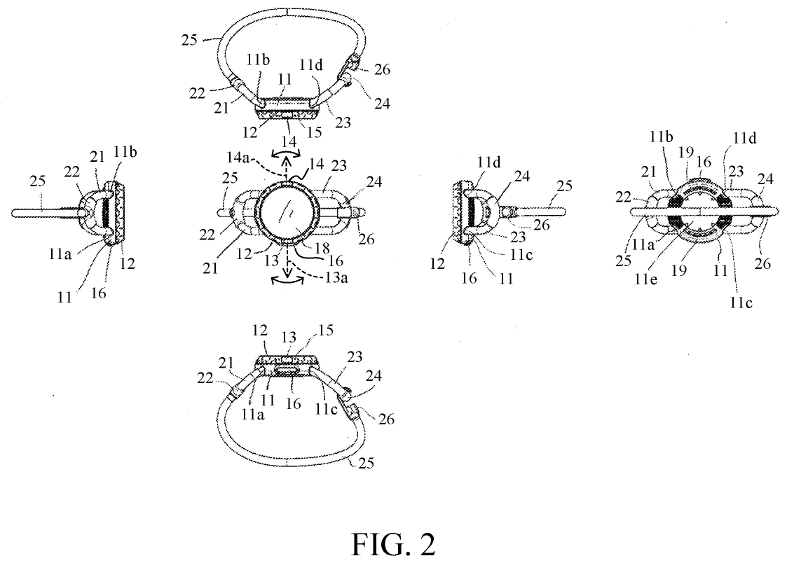

FIGS. 1 and 2 illustrate an image pickup apparatus (wearable camera) 10 according to a first embodiment of the disclosure. FIG. 1 illustrates an image pickup apparatus 10 viewed from diagonally upward and diagonally downward. FIG. 2 illustrates the image pickup apparatus 10 in six directions including the top and bottom. The image pickup apparatus 10 includes a body 11, attachment members (21 to 26), a rotating member 12, a plurality of (two in this embodiment) imaging units 13 and 14, and a display unit 18.

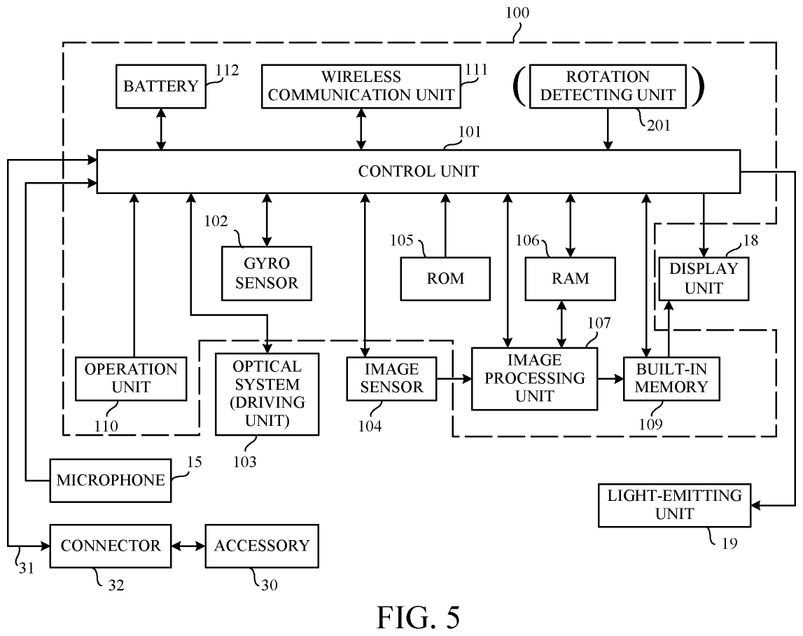

The body 11 has a disc shape, and houses a control processing circuit (100 in FIG. 5) described below. The operation members are provided at a plurality of locations in the circumferential direction of the outer circumference portion of the body 11. The plurality of operation members include an imaging switch unit 16 that protrudes from the outer circumference portion of the body 11 as illustrated, an unillustrated power switch unit, and the like. Tapping or pressing the imaging switch unit 16, the user can instruct the imaging units 13 and 14 to capture images.

For example, a still image for recording may be captured by the tap operation of the imaging switch unit 16, and a moving (motion) image for recording may be started or stopped by the pressing operation of the imaging switch unit 16. At this time, in order to avoid imaging of a blurred image caused by the shake of the image pickup apparatus 10 by the operation of the imaging switch unit 16, imaging may be started a predetermined time after the operation. The image pickup apparatus 10 can be powered on and off when the user presses the power switch unit.

One or more operation members that are drawable or rotatable by one or more stages, like a crown of a watch, may be provided on the outer circumference portion of the body 11.

Strap fixing portions 11a to 11d are provided at four locations in the circumferential direction on a lower surface side of the outer circumference portion of the body 11. The attachment members (straps) include two first string-shaped portions 21 and 23 each having a U-shape, and both ends of each of the first string-shaped portions 21 and 23 are located at two of four locations of the strap fixing portions 11a to 11d in the circumferential direction so that the first string-shaped portion 21 is fixed to the strap fixing portions 11a and 11b, and the second string-shaped portion 23 is fixed to the strap fixing portions 11c and 11d.

The attachment member includes the two first string-shaped portions 21 and 23 described above, resin connecting members 22 and 24 attached to the middle portions of the first string-shaped portions 21 and 23, respectively, a second string-shaped portion 25 connected to the connecting member 22 at one end, and an engagement member (hook) 26 attached to the other end of the second string-shaped portion 25. Each string-shaped portion includes a lightweight string-shaped member having a high tensile strength (withstand load) such as a climbing rope or a paracord.

In this embodiment, the first string-shaped portions 21 and 23 are divided into two, but the first string-shaped portions 21 and 23 may be connected in the body 11 to form a single ring-shaped string member. That is, the first string-shaped portions 21 and 23 may be fixed to the body 11 so as to extend from two of four locations in the circumferential direction of the body 11 in a U-shape (a V-shape or another shape).

In attaching the image pickup apparatus 10 to the wrist, the user puts the body 11 on the wrist, winds the first and second string-shaped portions 21, 23, and 25 around the wrist, and engages the engagement member 26 with the connecting member 24. At this time, since the first string-shaped portions 21 and 23 are fixed at the four locations in the circumferential direction of the body 11 as described above, the body 11 can be more stably supported on the wrist than that in the case where the string-shaped portions are fixed at only two locations in the circumferential direction. Thus, using the attachment member as in this embodiment can facilitate an attachment of the image pickup apparatus 10 to the body (wrist) and maintain a stable attachment state of the image pickup apparatus 10.

A lock mechanism may be provided to prevent the engagement member 26 from being easily disengaged from the connecting member 24. The second string-shaped portion 25 may be made longer, its middle portion may be wound around the connecting member 24 and folded back, and the engagement member 26 may be engaged with the connecting member 22. Thereby, the user can engage the engagement member 26 with the connecting member 22 while the body 11 is stably pressed against the wrist and the second string-shaped portion 25 is pulled. That is, the image pickup apparatus 10 can be more easily attached.

The image pickup apparatus 10 according to this embodiment is attachable not only to the wrist of the user but also to various parts of his body such as his head, torso, thigh, and ankle. More specifically, a plurality of first string-shaped portions 21 and 23 or a plurality of second string-shaped portions 25 having various lengths according to attached portions are prepared, and they are attached to the connecting member 22 so as to be removable and replaceable. Entwining, tying, or engaging the second string-shaped portion 25 can attach the image pickup apparatus 10 to a place other than the body, such as a bicycle or a still object of the personal belongings. For example, the engagement member 26 can be engaged with a projecting object installed on a ceiling or a wall. The attachment member itself may be removable from the body 11. In the case where the attachment member is detachable from the body 11, the user can select the attachment member of a different material or color depending on the using situation. This is similarly applied to a second embodiment described below.

The rotating member 12 is a ring-shaped member corresponding to a bezel of a watch, and is attached to the body 11 so as to be rotatable in the circumferential direction as illustrated by an arrow. The body 11 includes an unillustrated holder that rotatably holds the rotating member 12. Anon-slip knurl is formed on the outer circumference portion of the rotating member 12 so that the user can easily rotate the rotating member 12. The imaging units 13 and 14 are provided at two locations on the outer circumference portion of the rotating member 12 at an interval of 180° in the circumferential direction.

Each imaging unit includes an optical system (103 in FIG. 5) that forms an object image, and an image sensor (104 in FIG. 5) such as a CCD sensor or a CMOS sensor that captures (photoelectrically converts) the object image. The optical system includes driving units that drive optical elements for a diaphragm (aperture stop), a shutter, autofocusing, zooming, and the like.

As illustrated in the top view of FIG. 2, an imaging direction 13a of the imaging unit 13 and an imaging direction 14a of the imaging unit 14 each face the radially outside of the rotating member 12 and face opposite directions. The imaging directions 13a and 14a are changed as the rotating member 12 is rotated relative to the body 11. Thus, the user can arbitrarily select the imaging directions 13a and 14a by simply rotating the rotating member 12 with the other hand without moving the wrist or arm to which the image pickup apparatus 10 is attached.

The imaging units 13 and 14 may have the same optical characteristics but may have different imaging angles of view (focal lengths of the optical systems). For example, the imaging angle of view of the imaging unit 13 may be set to a size suitable to capture an image of the external world viewed from the user such as a landscape, and the imaging angle of view of the imaging unit 14 may be set to a size larger than that of the imaging unit 13 which is suitable for the user to capture a selfie. Providing the two imaging units 13 and 14 having different imaging angles of view in this way can provide imaging with two types of imaging angles of view without the user operation of adjusting the imaging angle of view.

The imaging units 13 and 14 may have different sizes and the numbers of pixels of the image sensors from each other. The imaging units 13 and 14 may have imaging angles of view equal to each other, or imaging units having different imaging angles of view may be provided at three or more locations in the circumferential direction of the rotating member 12.

A microphone 15 for recording sound is provided near the imaging units 13 and 14 on the outer circumference portion of the rotating member 12, and can acquire sounds in the imaging directions of the imaging units 13 and 14. During imaging for recording, sounds are recorded through the microphone 15 together with the image.

The display unit 18 includes a liquid crystal display element, an organic EL element, or the like, and is provided in an area on the inner diameter side of the outer circumference portion of the rotating member 12. The display unit 18 displays images that are being captured by the imaging units 13 and 14. The user can allow the imaging units 13 and 14 to perform imaging while checking the images displayed on the display unit 18. The operations of the imaging units 13 and 14 and the display unit 18 are controlled by the control processing circuit in the body 11.

The display unit 18 attached to the rotating member 12 may be rotatable with the rotation of the rotating member 12, or the display unit 18 may be provided on the body 11 so as not to rotate with the rotation of the rotating member 12. An orientation of an image displayed on the display unit 18 may be controlled so that the orientation is natural for the user regardless of the rotation position of the display unit 18. The display unit 18 can also display an image that has already been imaged and recorded, an imaging menu that can be selected by the user, and various information, such as map information illustrating an area around its position acquired by a GPS receiver unit included in the control processing circuit, and time information indicating the current time.

FIG. 5 illustrates an electrical configuration of the image pickup apparatus 10 according to this embodiment. FIG. 5 illustrates the control processing circuit 100 in the body 11, the optical system (driving unit) 103 and the image sensor 104 in the imaging units 13 and 14, the display unit 18, the microphone 15, and light-emitting units 19. The body 11 may include an unillustrated speaker.

The control processing circuit 100 includes an operation unit 110, a wireless communication unit 111, a control unit 101, an image processing unit 107, a built-in memory 109, a ROM 105, a RAM 106, a gyro sensor 102, and a battery 112.

The operation unit 110 detects an operation of each operation member and outputs an operation signal. A touch panel sensor may be provided on the display unit 18 and included in the operation unit 110. The wireless communication unit 111 communicates image data and various information with the outside by wireless communication using Wi-Fi (registered trademark), Bluetooth (registered trademark), or the like. The wireless communication unit 111 may include the GPS receiving unit described above.

The control unit 101 includes a processor such as a CPU and an MPU, and controls each component in the image pickup apparatus 10 while reading a program built in the ROM 105 into the RAM 106 and expanding the program. For example, the control unit 101 controls imaging by the image sensor 104, and causes the image processing unit 107 to generate image data from the imaging signal output from the image sensor 104. The control unit 101 causes the display unit 18 to display the generated image data, and also performs diaphragm control and autofocus control of the optical system (driving unit) 103 according to luminance information and focus information obtained from the image data. The control unit 101 performs zooming control for the optical system (driving unit) 103 according to a zooming operation in the operation unit 110.

The control unit 101 controls the shutter in accordance with the operation of the imaging switch unit 16 included in the operation unit 110 to cause the imaging units 13 and 14 to capture still images for recording, or to capture moving images for recording. The control unit 101 causes the display unit 18 to display the image data generated by the image processing unit 107, and records it in the built-in memory 109. The control unit 101 can also cause the display unit 18 to display the image data recorded in the built-in memory 109 and the image data received from the outside through the wireless communication unit 111.

The image processing unit 107 performs various image processing such as A/D conversion, white balance adjustment, color interpolation, and filtering for the imaging signal output from the image sensor 104 to generate the image data. The image processing unit 107 performs compression processing for the generated image data in accordance with a standard such as JPEG. The control unit 101 records the compressed image data in the built-in memory 109, or transmits the compressed image data to the outside through the wireless communication unit 111.

The gyro sensor 102 detects a movement of the body 11 and inputs angular velocity information to the control unit 101. The control unit 101 drives an image stabilizing lens in the optical system (driving unit) 103 or moves a cutout area in the image data from the image sensor 104 using the angular velocity information so as to reduce (correct) an image blur in the image data during imaging. The control unit 101 can detect that the user has intentionally shaken the image pickup apparatus 10 using the angular velocity information before imaging for recording, and start or end the imaging for recording.

In this embodiment, the control processing circuit 100 and other structures are provided in the body 11, but the control processing circuit 100 and other structures and operation members may be provided in the rotating member 12 and the body 11 may include the strap fixing portions 11a to 11d and the holder that rotatably holds the rotating member 12.

The battery 112 is a secondary rechargeable battery and supplies power to each component in the image pickup apparatus 10. The control unit 101 causes the display unit 18 to display the remaining capacity of the battery 112 and a warning in the case where the remaining capacity becomes lower than a predetermined value, and restricts the operation of the image pickup apparatus 10.

As illustrated in FIGS. 1 and 5, a conductive member (electrical wiring) 31 can be included in the first string-shaped portion 21 and the second string-shaped portion 25 so as to enable communication between the control unit 101 and an accessory 30 connected to a connector 32 fixed to the second string-shaped portion 25. The accessory 30 includes, for example, a heart rate sensor that measures the heart rate of the user. When the heart rate sensor and the control unit 101 communicate with each other through the conductive member 31, the heart rate measured by the heart rate sensor can be displayed on the display unit 18. Connecting a charger to the connector 32 can charge the battery 112 through the conductive member 31.

The communication between the accessory 30 and the control unit 101 may be performed by wireless communication using Bluetooth (registered trademark) or the like without using the conductive member 31.

As illustrated in FIGS. 1 and 2, light-emitting units 19 for emitting light according to the operations of the imaging units 13 and 14 (such as an imaging start, an imaging end, and an interruption of imaging) are provided on a surface of the body 11 on a wrist side (body side) of the user. Each light-emitting unit 19 also illustrated in FIG. 5 includes an LED or the like, and illuminates in different colors or at a different blinking interval depending on the operations of the imaging units 13 and 14 under the control of the control unit 101. Viewing the light emitted from the light-emitting unit 19 and leaking from a gap between the body 11 and the wrist of the user, the user can easily confirm the operation statuses of the imaging units 13 and 14.

Thus, this embodiment can realize a user-friendly image pickup apparatus in which the imaging direction can be easily changed only by rotating the rotating member 12.

Although the image pickup apparatus 10 according to this embodiment includes a plurality of imaging units 13 and 14 on the rotating member 12, only a single imaging unit may be provided on the rotating member. In this case, not only the imaging direction of the imaging unit may be changed according to the rotation operation of the rotating member, but also an imaging parameter such as an imaging angle of view may be changed according to the rotation operation of the rotating member. For example, when the rotating member is rotated so that the imaging direction of the imaging unit faces the external world, the imaging angle of view is set to an imaging angle of view suitable to image the external world. When the rotating member is rotated so that the imaging direction faces the user side, the imaging angle of view may be set to an imaging angle of view suitable for selfies. In this case, as illustrated by a parenthesis in FIG. 5, a rotation detecting unit 201 that detects a rotation position of the rotating member 12 may be provided.

A motor may be provided in the body 11 and the rotating member 12 may be rotationally driven by the driving force of the motor. This rotational driving during imaging for recording can automatically perform panoramic imaging.

The attachment member can use a belt-shaped member made of silicon or the like instead of the string-shaped member in this embodiment. In this embodiment, the attachment member uses the engagement member 26, but the attachment member may use a stretchable rope or the like for a simple structure, and an attachment may be realized by connecting two attachment members such as ropes fixed to the body 11 without providing the connecting members 22 and 24 or the engagement member 26.

### Second Embodiment

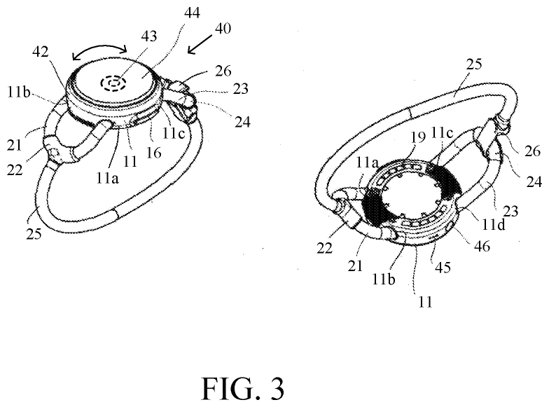

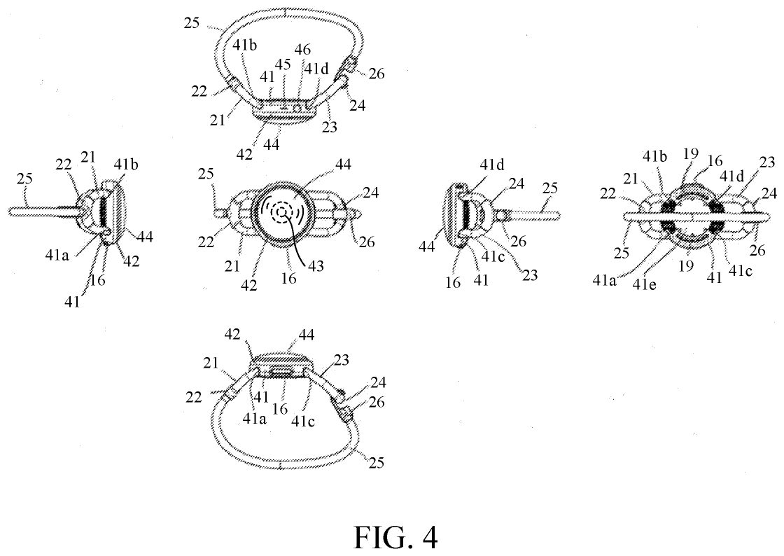

FIGS. 3 and 4 illustrate an image pickup apparatus 40 according to a second embodiment of the disclosure. FIG. 3 illustrates the image pickup apparatus 40 viewed from diagonally upward and diagonally downward. FIG. 4 illustrates the image pickup apparatus 40 in six directions including the top and bottom. The image pickup apparatus 40 includes a body 41, attachment members (21 to 26), a rotating member 42, and an imaging unit 43.

The body 41 has the same basic configuration as that of the body 11 in the first embodiment. However, in addition to the imaging switch unit 16, a microphone 45 and a power switch unit 46 are provided on the outer circumference portion of the body 41 in this embodiment. The body 41 has an electrical configuration similar to that illustrated in FIG. 5. In this embodiment, as illustrated in the parenthesis in FIG. 5, the rotation detecting unit 201 is provided and detects the rotation position of the rotating member 42. The light-emitting units 19 are provided at two locations in the circumferential direction of a back surface 41e of the body 41 similarly to the first embodiment.

The attachment member has the same configuration as that of the first embodiment, and both ends of each of the two first string-shaped portions 21 and 23 of the attachment member are fixed to two of four strap fixing portions 41a to 41d in the circumferential direction of the body 41, and the second string-shaped portion 25 and the engagement member 26 are provided so as to connect these two first string-shaped portions 21 and 23.

The rotating member 42 is a ring-shaped member corresponding to the bezel of a watch, and is rotatably attached to the body 41 in the circumferential direction. Although not illustrated, a non-slip knurl is formed on the outer circumference portion of the rotating member 42 so that the user can easily rotate the rotating member 42.

The imaging unit 43 is provided at the central portion (area on the inner diameter side of the outer circumference portion) of the rotating member 42, and a dome-shaped transparent cover 44 for covering the imaging unit 43 is fixed to the inner edge of the outer circumference portion of the rotating member 42.

The imaging unit 43 includes an optical system for forming an object image and an image sensor for capturing the object image, similarly to each imaging unit of the first embodiment. The optical system includes driving units that drive optical elements for a diaphragm, a shutter, autofocusing, zooming, and the like. The imaging direction of the imaging unit 43 is a direction (zenith direction) orthogonal to the rotation surface (horizontal plane) of the rotating member 42. The imaging unit 43 in this embodiment may have the same optical characteristic as that of the imaging unit in the first embodiment, but since there are few structural restrictions in this embodiment, the imaging unit 43 may have a wider imaging angle of view. For example, the imaging unit 43 may have a maximum imaging angle of view of 180° over the overall circumference (360°) in the circumferential direction.

When the rotating member 42 is rotated by the user, a zooming optical element in the optical system of the imaging unit 43 is driven under the control of the control unit in the body 41, or the imaging angle of view as an imaging parameter is changed by increasing or decreasing the size of the cutout area of the image data from the image sensor.

The imaging parameter other than the imaging angle of view, such as the number of imaging pixels (resolution) and a frame rate of moving image capturing, may be changed in accordance with the rotation operation of the rotating member 42. Setting the minimum frame rate can capture a still image (that is, moving image capturing and still image capturing can be switched).

This embodiment can provide a user-friendly image pickup apparatus in which an imaging parameter can be easily changed only by rotating the rotating member 42.

While this embodiment provides the rotating member 42, the imaging unit and the transparent cover may be provided to the body without providing the rotating member 42. Even in this case, using the attachment members (21 to 26) enables the image pickup apparatus to be easily attached to the body (wrist) or the like and maintains a stable attachment state of the image pickup apparatus.

While the disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

Each embodiment can provide an image pickup apparatus that allows a user to easily change the imaging direction and imaging parameters. The disclosure also provides an image pickup apparatus that is easy to wear and can maintain a stable wearing state.

What is claimed is:

1. An image pickup apparatus comprising:
a body including an attachment member for attachment;
a ring-shaped rotating member rotatable relative to the body; and
an imaging unit configured to capture an image,
wherein an imaging angle of view as an imaging parameter is changed by rotating the rotating member.

2. The image pickup apparatus according to claim 1, wherein the imaging unit is provided on an outer circumference portion of the rotating member.

3. The image pickup apparatus according to claim 2, wherein a plurality of imaging units are provided at a plurality of locations in a circumference direction on the outer circumference portion of the rotating member.

4. The image pickup apparatus according to claim 3, wherein the imaging angles of view of the plurality of imaging units are different from each other.

5. The image pickup apparatus according to claim 2, further comprising a display unit configured to display the image captured by the imaging unit in an area on an inner diameter side of the outer circumference portion of the rotating member.

6. The image pickup apparatus according to claim 1, wherein the imaging unit is provided in an area on an inner diameter side of the outer circumference portion of the rotating member.

7. The image pickup apparatus according to claim 1, further comprising a light-emitting unit located on a surface on an attachment side of the body and configured to emit light according to an operation of the imaging unit.

8. The image pickup apparatus according to claim 7, wherein the attachment member includes string-shaped members that include:
two first string-shaped portions fixed to the body and extending from two of four locations in a circumference direction of the body; and
a second string-shaped portion configured to connect the two first string-shaped portions.

9. The image pickup apparatus according to claim 8, wherein a plurality of string-shaped members having different lengths, each of which is the second string-shaped portion, are interchangeable relative to the first string-shaped portion.

10. The image pickup apparatus according to claim 1, wherein the attachment member includes a conductive member.

11. The image pickup apparatus according to claim 10, further comprising an accessory connectable to a connector provided on the attachment member and communicable with the body via the conductive member.

12. An image pickup apparatus comprising:
a body including an attachment member for attachment; and
an imaging unit configured to capture an image,
wherein the attachment member includes string-shaped members that include:
two first string-shaped portions fixed to the body and extending from two of four locations in a circumference direction of the body; and
a second string-shaped portion configured to connect the two first string-shaped portions.

13. The image pickup apparatus according to claim 12, wherein a plurality of string-shaped members having different lengths, each of which is the second string-shaped portion, are interchangeable relative to the first string-shaped portions.

14. The image pickup apparatus according to claim 12, wherein the attachment member includes a conductive member.

15. The image pickup apparatus according to claim 14, comprising an accessory connectable to a connector provided on the attachment member and communicable with the body via the conductive member.
